(19) United States
(12) Patent Application Publication
(10) Pub. No.: US 2016/0001728 A1
(43) Pub. Date: Jan. 7, 2016

(54) METHOD AND DEVICE FOR DETECTING THE PRESENCE OF OBJECTS IN A PASSENGER COMPARTMENT OF A VEHICLE

(71) Applicant: CONTINENTAL TEVES AG & CO. OHG, Frankfurt (DE)

(72) Inventors: Sighard Schräbler, Karben (DE); Ulrich Stählin, Eschborn (DE); Adam Swoboda, Groß-Gerau (DE); Georg Halasy-Wimmer, Vaihingen Enz (DE)

(73) Assignee: CONTINENTAL TEVES AG &CO. OHG, Frankfurt (DE)

(21) Appl. No.: 14/765,433

(22) PCT Filed: Feb. 3, 2014
(86) PCT No.: PCT/EP2014/052023

§ 371 Date: Aug. 3, 2015

(30) Foreign Application Priority Data
Feb. 5, 2013 (DE) 10 2013 201 836.3

(51) Int. Cl. B60R 21/015; G01S 13/04

(52) U.S. Cl. CPC B60R 21/015; G01S 13/04

(57) ABSTRACT

A method and device for detecting the presence of objects in a passenger compartment of a vehicle, wherein electromagnetic signals are radiated into the passenger compartment. The signals are reflected in accordance with at least one object property of at least one object that is present in the passenger compartment. The reflected signals are received and are evaluated with regard to the at least one object property. The method is performed by a vehicle-to-X communication device that communicates wirelessly.

### CROSS REFERENCE TO RELATED APPLICATIONS

This application is the U.S. National Phase Application of PCT International Application No. PCT/EP2014/052023, filed Feb. 3, 2014, which claims priority to German Patent Application No. 10 2013 201 836.3, filed Feb. 5, 2013, the contents of such applications being incorporated by reference herein.

### FIELD OF THE INVENTION

The invention relates to a method for detecting the presence of objects in a passenger compartment of a vehicle and a device for detecting the presence of objects in a passenger compartment of a vehicle.

### BACKGROUND OF THE INVENTION

In the prior art, it is already known to equip motor vehicles with vehicle-to-X communication devices for message transmission, and also with different sensor devices for environment detection, such as e.g. with camera or radar devices. All of these devices are aligned in relation to the environment outside the vehicle and normally serve in the context of driver assistance systems to improve vehicle safety, in particular occupant safety. Devices for detecting a seat occupancy in the vehicle are similarly known in the prior art, such as e.g. so-called seat occupancy mats. These also serve to improve occupant safety.

In this connection, DE 10 2006 050 214 A1, which is incorporated by reference discloses a lane detection method for supporting a driver in driving with a vehicle. A lane detection is initially undertaken, e.g. by means of infrared sensors, camera sensors or radar sensors. A lane change is detected on the basis of the evaluation of the sensor signals according to features representing the surface characteristics of the road and the edge of the road. If it is then detected that the vehicle is leaving the lane without the indicator having been actuated, a warning signal is issued to the driver. The warning signal may be visual, audible or haptic.

A method for detecting hidden objects in road traffic is known from DE 10 2007 048 809 A1, which is incorporated by reference. The environment of a vehicle and movement variables of the vehicle are detected by sensors. This information is transmitted by means of vehicle-to-vehicle communication to vehicles located in the environment. Similarly, environment and movement information is simultaneously detected by vehicles located in the environment. The received information is used to extend an environment model. The environment model extended in this way is presented in updated form by means of a display in the vehicle and can be made available to one or more vehicle assistance systems. Information on objects which cannot be detected by the vehicle sensors themselves is thus available in the vehicle.

A method for detecting the presence of the vehicle driver on the driving seat by means of a seat occupancy mats is disclosed, inter alia, in DE 10 2008 016 659 A1, which is incorporated by reference. Alternatively, the presence or the position of the vehicle driver can be detected by means of a camera or by means of an ultrasound system.

DE 10 2004 032 473 A1, which is incorporated by reference describes an evaluation method and an evaluation device for a system for seat occupancy detection. A vehicle seat is illuminated by means of an electromagnetic wave field. The wave field may be high-frequency or low-frequency. The vehicle seat has reflectors at a plurality of different places which reflect the wave field and simultaneously modulate the reflected wave field. If a reflector is hidden, for example by a person located on the seat, the corresponding reflector cannot reflect the wave field. A receiver then receives the reflected wave fields and performs an allocation to the respective reflectors on the basis of the modulations contained therein. This enables not only a seat occupancy detection per se, but additionally a detection of the assumed position of a person on the seat.

### SUMMARY OF THE INVENTION

However, it is disadvantageous in the methods and devices known from the prior art that sensor devices in addition to the outwardly aligned sensors must be provided for seat occupancy detection within the vehicle, resulting in an additional production overhead and therefore cost expenditure.

An aspect of the invention proposes a method which enables a reduction in the sensor outlay necessary according to the prior art for detecting objects within the vehicle.

An aspect of the invention relates to a method for detecting the presence of objects in a vehicle compartment of a vehicle, wherein electromagnetic signals are radiated into the passenger compartment, wherein the signals are reflected in accordance with at least one object property of at least one object that is present in the passenger compartment, and wherein the reflected signals are received and evaluated with regard to the at least one object property. The method is characterized in that it is carried out by a wirelessly communicating vehicle-to-X communication device.

This offers the advantage that no additional sensor system needs to be provided for detecting the presence of objects in the passenger compartment of the vehicle, since a wirelessly communicating vehicle-to-X communication device already present in the vehicle is used instead. It is assumed according to the current state of technology that, in the near future, at least within the European Union, new vehicles will be equipped as standard with a vehicle-to-X communication device of this type.

Since a vehicle-to-X communication device normally also performs its primary task, i.e. wireless communication, by means of the transmission or radiation and reception of electromagnetic signals, no costly modifications therefore need to be made to the vehicle-to-X communication device in order to enable said device to carry out the method according to the invention. The signals used for wireless communication can also be used without modification for detecting the presence of objects in the passenger compartment as well as for communication.

The term “object property” is understood according to the invention to mean the property of an object which characterizes the reflected signal. This may be e.g. a surface characteristic of the object which characterizes the intensity of the reflected signal, a position of the object which characterizes e.g. a phase behavior of the reflected signals and therefore an interference behavior, or a movement behavior which characterizes e.g. a frequency shift of the reflected signals. These object properties are thus present as information in the reflected signal and, with corresponding evaluation, allow a detection of the presence of the objects having the object property in the passenger compartment.

The objects within the meaning of the invention are preferably vehicle occupants, but may also be inanimate objects, such as e.g. luggage.

The objects are advantageously assigned to a vehicle seat. This simplifies the detection of the presence of the objects in the passenger compartment insofar as they are expected at fixed, predefined positions and can thus be searched for in a targeted manner.

It is furthermore provided that the messages contained in the received signals are evaluated at least proportionally by the vehicle-to-X communication device, particularly if they have been transmitted by other vehicle-to-X communication devices. The vehicle-to-X communication device thus continues to be used for its primary task.

It is preferably provided that the at least one object property is determined from a Doppler frequency of the reflected signals. The Doppler frequency is produced by a movement of the object which reflects the signal and describes a change in the frequency or wavelength of the reflected signal compared with the radiated signal. It has become evident that the evaluation of the Doppler frequency enables a robust, reliable and precise detection of the presence of different objects in the passenger compartment.

According to a further preferred embodiment of the invention, it is provided that the Doppler frequency is filtered by means of a low-pass filter, in particular by means of a digital low-pass filter. Depending on the design of the low-pass filter, this has the effect that Doppler frequencies which exceed a defined limit frequency are filtered and not used for the further evaluation. Frequency ranges of the Doppler frequencies that are irrelevant to the method according to the invention can thus be excluded from the evaluation, allowing a reduction in the processing power required for the evaluation. This in turn enables the use of less powerful and therefore less costly processing modules. The evaluation of the Doppler frequencies or reflected signals in terms of the object properties can thus be performed very efficiently by a processing module already present in the vehicle-to-X communication device. No additional processing module or replacement of the processing module already present with a more powerful processing module is therefore required.

It is preferably provided that the at least one object property describes a movement behavior. The term “movement behavior” is to be broadly interpreted within the meaning of the invention and describes not only a “gesticulation” of persons or a general motionlessness of luggage items, but additionally in fact any type of movement. The movement behavior of an object, regardless of whether it is an animate or inanimate object, is particularly well suited to detecting the presence of this object in the passenger compartment, since the movement behavior of an object differs significantly from the movement behavior of an unoccupied vehicle seat. Even the movement behavior of a luggage item differs recognizably from that of an unoccupied vehicle seat due to forces and vibrations acting on the luggage item during the journey. As has become evident, even the pulse beat of a person can be detected by means of the method according to the invention, since even the beating of the human heart causes a movement on the surface of the body detectable with the method according to the invention. Reliable evidence indicating whether objects are present in the passenger compartment can thus be provided by the movement behavior. The detection of the pulse beat of a person has proven to be particularly readily feasible by means of a signal wavelength of around 6 GHz. This signal wavelength essentially corresponds to the wavelength used for WLAN communication according to IEEE 802.11p.

It is particularly preferably provided that a distinction is made between animate and inanimate objects on the basis of the movement behavior. Since, apart from comparatively expansive movements, such as, for example, arm and leg movements of persons, as already described, even the pulse beat of a person can be detected, a reliable distinction can be made between animate and inanimate objects. This information can be used, e.g. in the event of an accident of the vehicle, by the existing safety systems, e.g. to adjust the ignition settings of airbags within the passenger compartment or for the transmission of an automated emergency call which includes the number of vehicle occupants.

In particular, is particularly preferred that a distinction is made between children or young people and adults. This can be done, for example, via the characteristic movement behavior of children or young people compared with adults, since children or young people are generally significantly more restless than adults. A distinction can also be made by means of Doppler frequency components of the reflected signal which describe vibrations of the vehicle seat on which the person is located. Since a child covers only a smaller proportion of the surface of the vehicle seat compared to an adult, the reflected signal is characterized comparatively more markedly due to the vibrations of the vehicle seat. A combination of both distinction options is also preferred.

It is furthermore preferred that the movement behavior of a vehicle is monitored for decreasing movement intensity. A decreasing movement intensity can be detected e.g. via a decreasing pulse beat or in total via a decrease in the characteristic of the reflected signal due to Doppler frequencies. This offers the advantage that inferences can be made regarding the condition of the vehicle driver, in particular his fitness to drive, which frequently decreases when longer journeys are made and thus represents a potential risk. If it is detected that a movement intensity and a fitness to drive of the vehicle driver associated therewith have fallen below a level regarded as critical, said driver can thus be warned and made aware that he is in a critical condition in terms of fitness to drive. The vehicle driver can also be woken up after momentarily nodding off. The vehicle driver is to be understood here as an object within the meaning of the invention.

It is appropriate that the movement behavior of a plurality of objects is monitored separately. This offers the advantage that a multiplicity of different objects are not only detected as present, but can also be distinguished. This information can be used, for example, for safety systems.

It is provided that a transmitting power of the signal is set for a predefined time interval in such a way that the signal does not interfere with a wireless communication taking place outside the passenger compartment. This initially offers the advantage that the method according to the invention can be carried out separately from a communication method that is taking place, wherein it is irrelevant whether the vehicle-to-X communication device of the vehicle carrying out the method is participating in the communication outside the passenger compartment or not. The method according to the invention is thus highly flexible. Furthermore, it offers the advantage that the objects in the vehicle are exposed to only a reduced radiation power which, although it results in no verifiable changes in terms of the harmlessness to health of the method according to the invention which is in any case guaranteed, is nevertheless normally perceived psychologically as very positive.

In particular, it is provided that the signal is radiated free from the constraints of a communication protocol of the vehicle-to-X communication device. Since the transmitting power of the signal is set in such a way that the signal does not interfere with a wireless communication taking place outside the passenger compartment, no consideration needs to be given to any communication protocols that might be used. Thus, for example, a signal can be radiated which continues uninterrupted over a time period of one or more seconds. This further improves the reliability and accuracy of the presence detection according to the invention.

It is furthermore preferred that the passenger compartment is monitored for movements by means of the method when the vehicle ignition is switched off. This offers the advantage that the presence of objects is detected inside the passenger compartment even when the vehicle ignition is switched off. This information may be used, for example, to provide an alarm functionality in order to detect an unauthorized entry into the vehicle. As a consequence of the unauthorized entry, for example, the emission of loud warning tones and visual signals can be triggered. In some cases, it may be appropriate to link the triggering of an alarm functionality of this type to further criteria such as e.g. the condition of a central locking system.

An aspect of the invention furthermore relates to a device for detecting the presence of objects in a passenger compartment of a vehicle, comprising a transceiver, a multiplicity of antenna elements and evaluation means, wherein the transceiver radiates electromagnetic signals into the passenger compartment by means of the multiplicity of antenna elements, wherein the signals are reflected in accordance with at least one object property of at least one object that is present in the passenger compartment, and wherein the transceiver receives the reflected signals by means of the multiplicity of antenna elements and forwards them to the evaluation means which evaluate the reflected signals in terms of the at least one object property. The device according to the invention is characterized in that the transceiver is a wirelessly communicating vehicle-to-X communication device and a boresight of at least one antenna element points into the passenger compartment.

This offers the advantage already described that a vehicle-to-X communication device already present in the vehicle is used without additional production outlay and cost expenditure for detecting the presence of objects in the passenger compartment of the vehicle. Since a boresight of at least one antenna element points into the passenger compartment, this offers a further advantage that the passenger compartment, i.e. the area to be monitored, in which a presence detection is to take place is comparatively well illuminated with the signals.

The device according to an aspect of the invention thus offers an economical and reliable alternative to the so-called seat occupancy mats frequently used in the prior art. Similarly, the ultrasound devices used in the prior art for seat occupancy detection can be advantageously replaced with the device according to the invention, since the device according to the invention is not only economical, but, in addition, also has no negative effects on domestic animals such as e.g. dogs, which can respond very sensitively to ultrasound.

The boresight of an antenna element is dependent on the geometry of the respective antenna element. The relationship between the geometry and boresight of an antenna element constitutes general technical knowledge.

It is provided that at least one antenna element is arranged on or in a windscreen of the vehicle and/or that at least one antenna element is arranged on or in a vehicle roof of the passenger compartment. An arrangement on or in the windscreen offers the advantage that the signals can be radiated both comparatively well forward away from the vehicle and into the passenger compartment. A good communication capability and a reliable presence detection are thus guaranteed. In particular, an arrangement of this type enables a particularly simple presence detection for objects on the driver's seat and on the front passenger seat, since these are directly illuminated with the signals in an arrangement of this type. Any possibly necessary switchover process between antenna elements used for communication and for carrying out the method according to the invention is thus superfluous, since an antenna element arranged on or in the windscreen simultaneously meets both requirements.

The arrangement on the windscreen can be implemented e.g. by means of gluing. In the case of an arrangement in the windscreen, the antenna element can already be integrated into said windscreen during the manufacture of the windscreen and can have an electrical interface for its contacting.

So-called antenna patches which are essentially designed as two-dimensional and have two opposing boresights which in each case point away in opposite directions from the two-dimensional surface are suitable for the arrangement on or in the windscreen.

Conversely, an arrangement on or in the vehicle roof enables not only a circular radiation around the vehicle, as a result of which a comparatively large spatial area is covered for communication purposes, but also a radiation from above into the passenger compartment. However, the use of antenna patches is less suitable in this case, since said patches, due to their geometry, have boresights that cannot point simultaneously into the passenger compartment and in a circular manner into the vehicle environment around the vehicle. The arrangement on or in the vehicle roof furthermore offers the advantage that an antenna element can be arranged above each vehicle seat, so that each vehicle seat can be individually illuminated. The deactivation of a vehicle ventilation, for example, can thus be avoided as long as persons remain in the vehicle, irrespective of the seat on which they are located.

Along with a presence detection for each individual vehicle seat, the monitoring of individual vehicle seats offers the additional facility of deriving evidence from the number of objects detected as present, indicating whether an unobstructed view exists for the vehicle driver.

An arrangement on the vehicle roof is preferably implemented on the inside of the vehicle roof, since a better detection of the presence of objects in the passenger compartment is thus possible.

An arrangement in a vehicle roof is understood to mean an arrangement penetrating the vehicle roof which positions the antenna element partially on both the outside and the inside of the vehicle roof.

It is furthermore provided that at least one antenna element is arranged completely inside the passenger compartment. This offers the advantage that the passenger compartment is comparatively well and completely illuminated by this antenna element, since all boresights point in this case into the passenger compartment.

It is preferred that the evaluation means determine a Doppler frequency from the reflected signals. As already described, the Doppler frequency of the reflected signals enables a robust, reliable and precise detection of the presence of different objects in the passenger compartment. For example, the Doppler frequency can be determined from the Doppler phases, if the signals are temporally too short to completely cover a signal period. The time duration of the signals is essentially characterized by the communication protocol that is used.

It is moreover preferred that the device uses a first number of antenna elements exclusively for reception and a second number of antenna elements exclusively for transmission, wherein, in particular, the boresights of the first number of antenna elements point into the passenger compartment. This offers the advantage, for example, that an individual antenna element that is located e.g. in the windscreen can be used to transmit the signals, whereas two antenna elements independent from one another are used exclusively to receive the reflected signals, wherein one of the antenna elements used exclusively for reception is allocated e.g. to the vehicle driver and the other to the front-seat passenger. In a simple manner, this enables a simultaneous detection and observation of both the vehicle driver and the front-seat passenger without communication processes being influenced or interrupted. A method of this type by means of transmit and receive antenna elements spatially separated from one another is generally also known as a bistatic method.

In particular, it is preferred that the antenna elements of the first number, which are used exclusively for reception, are shadowed, e.g. by means of separators, in such a way that they can see exclusively a predefined segment of the passenger compartment or can receive exclusively reflected signals from the predefined segment of the passenger compartment. This segment preferably comprises a single vehicle seat. An interference-free and reliable monitoring of individual vehicle seats is thus possible.

Furthermore, it is preferred, in particular, that the device controls the antenna elements of the first number temporally staggered in relation to one another and/or controls the antenna elements of the second number temporally staggered in relation to one another. Not all antenna elements of the first or second number are thus simultaneously controlled. This offers the advantage that, through corresponding control, in each case only one segment of the passenger compartment allocated to the respective antenna element is monitored. The reception of interference signals from a different segment of the passenger compartment is thus completely avoided. As a result, the method according to the invention is more reliable and robust.

It is particularly preferably provided that antenna elements of the first number and of the second number allocated to one another are controlled in a synchronized manner. Antenna elements allocated to one another are antenna elements jointly responsible for the monitoring of the segment of the passenger compartment. Antenna elements allocated to one another are therefore e.g. two antenna elements of which the antenna element of the second number transmits a signal which is received by the allocated antenna element of the first number. This offers the advantage that the presence detection is even less prone to interference and even more robust.

It is furthermore advantageous that the device carries out the method according to the invention. This offers the advantages already described.

The vehicle-to-X communication device appropriately communicates by means of at least one of the following communication types:
WLAN communication, in particular according to IEEE 802.11p,
Wi-Fi Direct communication,
ISM communication (Industrial, Scientific, Medical Band), in particular via a radio-link-enabled locking device,
Bluetooth communication,
ZigBee communication,
UWB communication (Ultra Wide Band),
WiMax communication (Worldwide Interoperability for Microwave Access),
remote keyless entry communication,
mobile communication, in particular GSM, GPRS, EDGE,
UMTS communication,
LTE communication, and
infrared communication.

The mobile-based communication means are allocated, in particular, to an automatic emergency call module. Depending on the communication type that is used, different types of electronic signals are used accordingly for the method according to the invention.

If a two-channel communication type is used, such as e.g. WLAN communication according to IEEE 802.11p, a first channel can preferably be used continuously as a control channel which is reserved exclusively for communication purposes for vehicle safety devices. A second channel can then be switched over between a total of two different service channels. In this switchover, the second channel can also be used for a predefinable time period exclusively for the method according to the invention without a communication taking place. At least one antenna element used exclusively for transmission is preferably provided inside the passenger compartment for this purpose, said element radiating the signals with a reduced transmitting power and its boresights all pointing into the passenger compartment.

### BRIEF DESCRIPTION OF THE DRAWINGS

Further preferred embodiments can be found in the subclaims and the following description of an example embodiment with reference to figures.

In the figures:

FIG. 1 shows an example of the structure of a device according to the invention,

FIG. 2 shows schematically an attachment of the device according to the invention on a vehicle,

FIG. 3 shows a further example of the structure of the device according to the invention,

FIG. 4 shows a motor vehicle equipped with the device according to the invention, and

FIGS. 5a and 5b show an example of two determined Doppler frequencies which enable a determination of the underlying movement behavior.

### DETAILED DESCRIPTION OF THE PREFERRED EMBODIMENTS

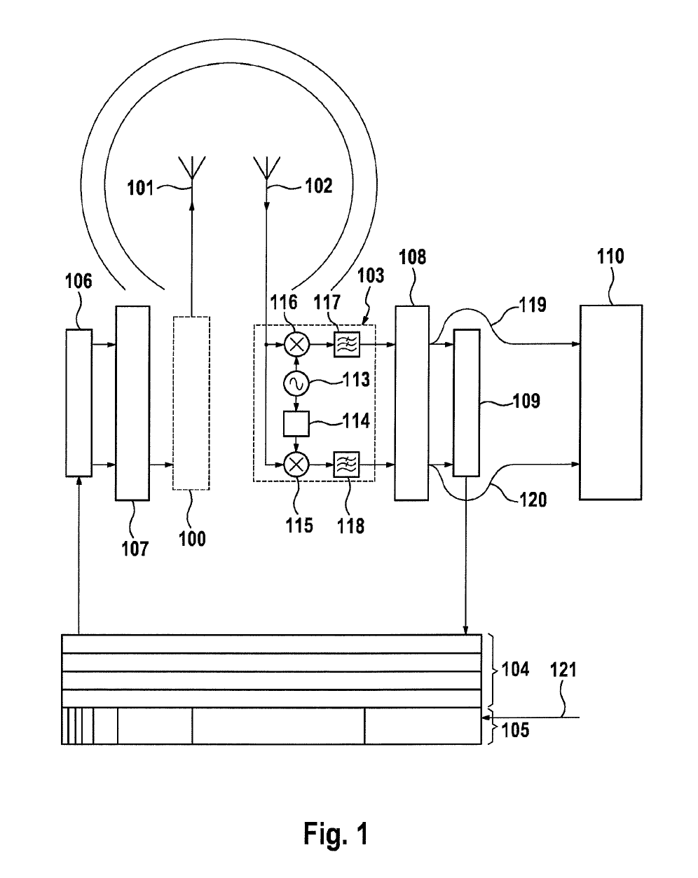

FIG. 1 shows an example of the structure of a device according to an aspect of the invention for detecting the presence of objects in a passenger compartment of a vehicle. The device comprises a transmit module 100, antenna elements 101 and 102, a receive module 103, a modulator 106 for generating a signal in digital form containing a vehicle-to-X message to be transmitted, a digital-analog converter 107 to convert the digital signal into an analog signal, an analog-digital converter 108 to convert a received signal into digital form, a demodulator 109 to demodulate the received signal in order to be able to further process said signal, and evaluation means 110 to determine a Doppler frequency from the received signal and to analyze a movement behavior of objects that are present from the Doppler frequency. The antenna element 101 is used exclusively for transmitting signals, whereas the antenna element 102 is used exclusively for receiving signals. A simultaneous transmission and reception is thus possible. Alternatively, a simultaneous transmission and reception by means of a so-called circulator or so-called bidirectional coupler could be enabled. The example of the device in each case transmits alternately in time on a first and a third WLAN channel during a WLAN communication according to 802.11p, while a second channel separating the first channel from the third channel remains unused. An information connection of different driver assistance systems 105 is guaranteed via the communication block 104 by means of the modulator 106 and demodulator 107. Driver assistance systems 105 can thus trigger the transmission of signals and can process received signals. The receive module 103 comprises, for example, a clock 113 which specifies a clock frequency of 5.9 GHz, which corresponds to the basic frequency of the WLAN 802.11p used by the vehicle-to-X communication device for communication. An identical clock is also comprised by the transmit module 100, but this is not shown in FIG. 1 for reasons of clarity. Furthermore, the receive module 103 comprises a delay element 114 which delays the clock signal output by the clock 113 via an adapted line length on the signal path to the mixer 115 similarly comprised by the receive module 103 through 90° compared with the mixer 116. This causes a splitting of the received signal into two components that are phase-shifted in relation to one another. A phase ambiguity of the Doppler frequency contained in the received signals can thus be resolved, since this is now processable as a complex number in the complex number plane rather than as a real number on a one-dimensional number string and thus has an additional dimension. The mixers 115 and 116 mix the components that are phase-shifted in relation to one another with the clock signal from the clock 113. The mixers 115 and 116 are followed in each case by low-pass filters 117 and 118 which filter the high-frequency components of the received signals in order to simplify and speed up a subsequent processing. Both signal components are forwarded via the parallel connections 119 and 120 following the digitization to evaluation means 110. In a first step, through frequency alignment of the transmitted signals with the received signals, the evaluation means 110 then determine a Doppler frequency contained in the signals and, in a second step, a movement behavior which underlies the Doppler frequency. In accordance with a request received via the data line 121, a frequency changeover of the transmit module 100, the transmission of the communication packet without information content or a change or deactivation of the communication protocol used can furthermore be triggered.

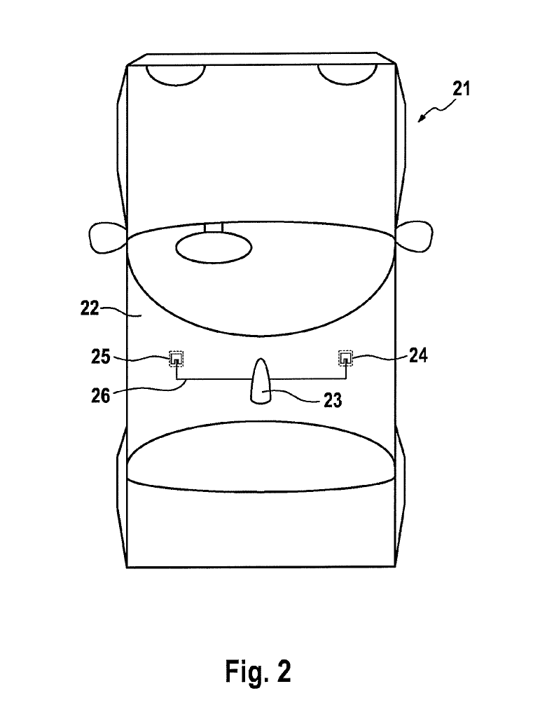

FIG. 2 shows a two-seater motor vehicle 21 with a device according to an aspect of the invention fitted thereto. The motor vehicle 21 has a vehicle roof 22 on which antenna elements 23, 24 and 25 are fitted. The antenna element 23 is an antenna element used for communication purposes. Accordingly, the alignment of the boresights of the antenna element 23 is such that radiation takes place primarily in the plane of the drawing. The antenna element 23 also has the best receive characteristics in this plane. The antenna elements 24 and 25 are so-called antenna patches which are essentially two-dimensional and are disposed on the inside of the passenger compartment. Accordingly, the antenna elements 24 and 25 have their boresights pointing into or out of the plane of the drawing. The antenna element 24 is disposed above the driver's seat, the antenna element 25 above the front passenger seat. All three antenna elements are capable of being used simultaneously for both transmission and reception by means of a circulator (not shown). The antenna elements 24 and 25 are controllable by means of a switchable connection 26 in order to illuminate the segments of the passenger compartment allocated to them and detect objects that are present. The antenna elements 24 and 25 are then controlled at short time intervals in order to determine the seat occupancy in the passenger compartment. The movement behavior of the objects present is simultaneously determined and, in particular, the movement intensity of the vehicle driver is observed in order to monitor his fitness to drive. An entry and exit into and from the vehicle and, where appropriate, an unauthorized entry into the vehicle are similarly monitored.

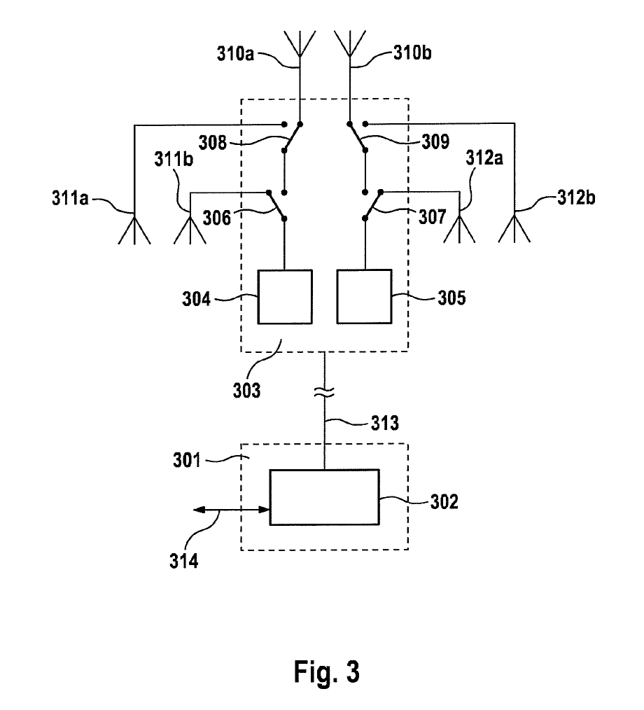

FIG. 3 shows schematically a possible structure of the device according to an aspect of the invention. It shows evaluation means 301 with a processor 302 for determining a Doppler frequency and the movement behavior of an object underlying the Doppler frequency, a vehicle-to-X communication device 303 with a transmit module 304, a receive module 305 and switchover units 306, 307, 308 and 309 to control the antenna elements 310a, 310b, 311a, 311b, 312a and 312b. The antenna elements 310a and 310b are used, for example, exclusively for communication with other communication devices, wherein signals are transmitted by means of the antenna element 310a and signals are received by means of the antenna element 310b. The antenna elements 311a and 311b are allocated to the driver's seat of a vehicle (not shown) and are used for detecting the presence of the vehicle driver. Signals are transmitted by means of the antenna element 311a and the reflected signals are received by means of the antenna element 311b. The antenna elements 312a and 312b are allocated to the front passenger seat and are used for detecting the presence of a front-seat passenger. Signals are transmitted by means of the antenna element 312a and the reflected signals are received by means of the antenna element 312b. The switchover units 306, 307, 308 and 309 enable a temporally staggered control of the individual antenna elements. The evaluation means 301 are connected via an HF line 313 to the vehicle-to-X communication device 303 with a user interface which, for example, can emit a warning tone in order to warn the vehicle driver if diminishing fitness to drive due to tiredness is detected.

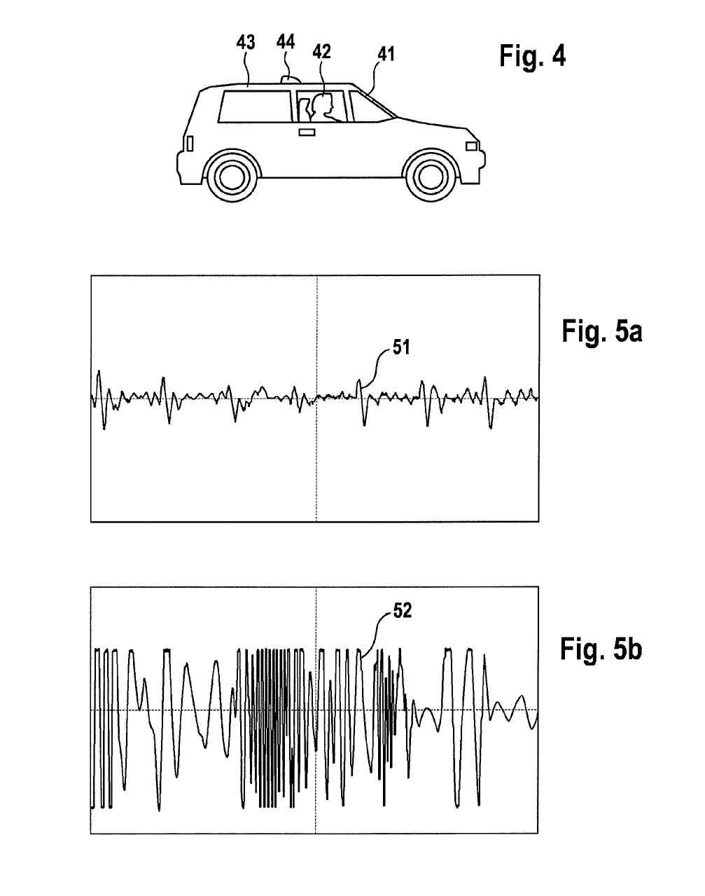

FIG. 4 shows a vehicle 43 in which a vehicle driver 42 is located. The vehicle 43 is equipped with the device according to the invention. An antenna element 44 which is used exclusively for communication with other vehicle-to-X communication devices is disposed on the vehicle roof of the vehicle 43. An antenna patch 41 which is used both for communication with other vehicle-to-X communication devices and for detecting the presence of objects on the driver's seat is furthermore disposed in the windscreen of the vehicle 43. The antenna element 41 has a boresight pointing to the driver's seat, illuminates the latter with electromagnetic signals and detects a Doppler frequency contained in the reflected signals.

FIG. 5 shows an example of two determined Doppler frequencies 51 and 52 which enable a determination of the respective underlying movement behavior of a vehicle driver. As can be seen, FIG. 5a shows the Doppler frequency 51 as comparatively weakly characterized. It has only a low amplitude with a cycle duration of around 2 Hz. On the basis of the low amplitude, it is detected that the vehicle driver is behaving essentially calmly. The period of 2 Hz is the pulse of the vehicle driver, which corresponds to 120 heart beats per minute. On the basis of the high pulse, it is thus detected that the vehicle driver is awake and alert despite his calm movement behavior.

Conversely, the Doppler frequency 52 shown in FIG. 5b has such a high amplitude that the pulse of the vehicle driver is no longer detectable therein. The high amplitude is triggered by an intensive movement behavior of the vehicle driver. The measured period of around 10 Hz is generated by the different movements of the vehicle driver. In this case, it is detected on the basis of the high amplitude that the vehicle driver is awake and alert.

1. A method for detecting the presence of objects in a vehicle compartment of a vehicle, wherein electromagnetic signals are radiated into the passenger compartment, wherein the signals are reflected in accordance with at least one object property of at least one object that is present in the passenger compartment, and wherein the reflected signals are received and evaluated with regard to the at least one object property, wherein
the method is carried out by a wirelessly communicating vehicle-to-X communication device.

2. The method as claimed in claim 1, wherein
the at least one object property is determined from a Doppler frequency of the reflected signals.

3. The method as claimed in claim 1, wherein
the at least one object property describes a movement behavior.

4. The method as claimed in claim 3, wherein
a distinction is made between animate and inanimate objects on the basis of the movement behavior.

5. The method as claimed in claim 3, wherein
the movement behavior of a vehicle driver is monitored for decreasing movement intensity.

6. The method as claimed in claim 3, wherein
the movement behavior of a plurality of objects is monitored separately.

7. The method as claimed in claim 1, wherein
a transmitting power of the signal is set for a predefined time interval in such a way that the signal does not interfere with a wireless communication taking place outside the passenger compartment.

8. The method as claimed in claim 7, wherein
the signal is radiated free from the constraints of a communication protocol of the vehicle-to-X communication device.

9. The method as claimed in claim 1, wherein
the passenger compartment is monitored for movements when the vehicle ignition is switched off.

10. A device for detecting the presence of objects in a passenger compartment of a vehicle, comprising:
a transceiver,
a multiplicity of antenna elements and
evaluation means,
wherein the transceiver radiates electromagnetic signals into the passenger compartment by the multiplicity of antenna elements, wherein the signals are reflected in accordance with at least one object property of at least one object that is present in the passenger compartment, and wherein the transceiver receives the reflected signals by the multiplicity of antenna elements and forwards them to the evaluation means which evaluate the reflected signals in terms of the at least one object property, wherein
the transceiver is a wirelessly communicating vehicle-to-X communication device and a boresight of at least one antenna element points into the passenger compartment.

11. The device as claimed in claim 10, wherein
at least one antenna element is arranged on or in a windscreen of the vehicle and/or at least one antenna element is arranged on or in a vehicle roof of the passenger compartment.

12. The device as claimed in claim 10, wherein
at least one antenna element is disposed completely inside the passenger compartment.

13. The device as claimed in claim 10, wherein
the evaluation means determine a Doppler frequency from the reflected signals.

14. The device as claimed in claim 10, wherein
the device uses a first number of antenna elements exclusively for reception and a second number of antenna elements exclusively for transmission, wherein, in particular, the boresights of the first number of antenna elements point into the passenger compartment.

15. The device as claimed in claim 14, wherein
the device controls the antenna elements of the first number temporally staggered in relation to one another and/or controls the antenna elements of the second number temporally staggered in relation to one another.

16. The device as claimed in claim 10, wherein
the device carries out a method as claimed in claim 1.
